(19) United States
(12) Patent Application Publication
(10) Pub. No.: US 2018/0223435 A1
(43) Pub. Date: Aug. 9, 2018

(54) DISK BLADE WITH HARD FACE AND SEED DISK OPENER INCORPORATING SAME

(71) Applicants: Keith A. Johnson, West Bend, WI (US); Andrew J. Theisen, Fond du Lac, WI (US)

(72) Inventors: Keith A. Johnson, West Bend, WI (US); Andrew J. Theisen, Fond du Lac, WI (US)

(73) Assignee: Kondex Corporation, Lomira, WI (US)

(21) Appl. No.: 15/891,592

(22) Filed: Feb. 8, 2018

Related U.S. Application Data
(60) Provisional application No. 62/456,400, filed on Feb. 8, 2017.

(51) Int. Cl. C23C 24/10; B23K 26/00; C23C 28/04

(52) U.S. Cl. CPC C23C 24/103; B23K 26/0006; A01B 23/06; C23C 28/044; B23K 26/0066

(57) ABSTRACT

A disk such as but not limited to a seed opener disk is provided along with a seed opener assembly for a planter, that comprises a hard face coating along the beveled surface region. The hard face coating is preferably a laser cladding that forms a metallurgical bond with the underlying steel base material.

### CROSS-REFERENCE TO RELATED PATENT APPLICATION

This patent application claims the benefit of U.S. Provisional Patent Application No. 62/456,400, filed Feb. 8, 2017, the entire teachings and disclosure of which are incorporated herein by reference thereto.

### FIELD OF THE INVENTION

This invention generally relates to disk blades typically for use in agricultural or construction implements, and more particularly to wear resistance of such disk blades (and according to some of the various embodiments relate more specifically to wear resistant seed opener disks).

### BACKGROUND OF THE INVENTION

Various types of agricultural and construction disk blades are used for planting, field tillage, and other field or soil engagement operations. For example, disk blades may be used in harrows, plows, planters and other agricultural field implements and some construction implements. Such disk blades conventionally comprise a steel disk body defining a central aperture to facilitate mounting of the disk blade to the implement, and a circular blade edge at an outer periphery thereof. A circular beveled edge is arranged at the outer periphery that causes the disk body to converge at the tip end to form the circular blade edge that is able to more easily cut and penetrate the soil. Various wear resistance techniques for disk blades are known, such as exemplified by US 2014/0326367 to Hill entitled “Metal Coating Method”, U.S. Pat. No. 7,631,702 to Hansen, entitled Double-coated sintered hard-faced harrow disk blades”, and U.S. Pat. No. 4,729,802 to Matilis et al., entitled “Opener-disk heat-treating process and product,” the entire disclosures of which are hereby incorporated by reference to show the type of blades to which one or more inventive aspects herein may be applied.

Each blade is configured for a special purpose. An example of a specialized type of disk blade is a seed opener disk such as demonstrated by U.S. Pat. No. 4,729,802 to Matilis et al. Opener disks are used on planting equipment to create a furrow in the soil in which the seed is placed and subsequently covered by closing wheels on the planter. The sharpness and diameter of these disks are critical to the planting process. Accordingly, the disclosed embodiments herein relating to seed opener disk are designed to maintain the sharpness and diameter of these opening disks. However, other embodiments herein are contemplated to have applications to other types of agricultural and construction disks.

The sharpness of the seed opening disk is critical in today's no-till or minimum till applications. Due to the amount of crop residue left in the field in these farming practices, the opening disk must slice through this debris to facilitate a smooth and clean seed furrow. The sharp edge that exists when the disk is new quickly erodes to a rounded edge in abrasive soil conditions eliminating the disks ability to cut the residue. Disruptions in the seed furrow can lead to uneven seed placement which has been shown to have a negative effect on crop growth and subsequent yields.

The diameter of the disk is also a critical aspect of the disk. The depth at which the seed is placed in the ground has been proven to have a direct correlation to the emergence of the plant. Maintaining a consistent diameter of the disk facilitates a more consistent furrow depth over more acres for the farmer.

To date, most disks are typically produced from a heat treatable steel. These disks typically have a hardness in the 48-52 HRC in an effort to balance toughness and brittleness for this application. Products exist on the market that provide a coating of a higher hardness material to help improve the life of these products. For seed opener blades, these coatings have been of a coat and fuse process applied along the flat inner facing surface of the seed opener blade (see e.g. U.S. Pat. No. 4,729,802 to Matilis et al proposing a wear region along the inner flat surface). However, a coat and fuse process is susceptible to delamination due to its mechanical bond.

The invention provides improvements over the state of the art in relation to wear resistant disks. These and other advantages of the invention, as well as additional inventive features, will be apparent from the description of the invention provided herein.

### BRIEF SUMMARY OF THE INVENTION

The current coated seed opener disk blades on the market and in test are believed all use a coating on the surface opposite of the bevel in a steel disk body. In contrast, an embodiment herein coats the bevel and optionally a portion of the flat blade adjacent to the bevel to prevent wear along the beveled surface.

While a variety of hard facing materials, according to a preferred embodiment, a laser cladding is utilized that provides a metallurgical bond that is not susceptible to delamination.

In an embodiment such as a seed opener application, the hard faced bevel can be located in and outwardly facing orientation and toward the soil surface at the bottom as opposed to a protected inner surface. When laser cladding is used, the metallurgical bond is theorized to withstand the more direct engagement with a soil surface and/or crop residue.

In an embodiment, an opener disk comprises a steel disk body defining a central aperture and a circular blade edge at an outer periphery thereof. The steel disk body comprises a first flat side and a second side on opposite sides thereof. Each of the first flat side and a second side extending from the central aperture to the circular blade edge. The second side includes a circular beveled surface and a circular inner flat region. The circular beveled surface extends from the circular blade edge toward the central aperture and intersects the circular inner flat region. A hard face coating is on the circular beveled surface.

In a more specific embodiment, the hard face coating is applied along the second side such that the hard face coating does not extend around the circular blade edge onto the first flat side and/or the first side is completely free of the hard face coating.

In a more specific embodiment, the hard face coating extends to and intersects the circular blade edge.

In a more specific embodiment, the hard face coating extends over an outer circular portion of the inner flat region and over a corner between the circular beveled surface and the circular inner flat region.

In a more specific embodiment, the hard face coating extends over a limited portion of the second side, wherein the opener disk has a diameter of between 30 and 40 centimeters, and wherein the hard face coating has an innermost location between 3 millimeters and 30 millimeters radially inward from the circular blade edge.

In a more specific embodiment the hard face coating forms a raised plateau region along a surface of the steel disk body. The raised plateau region may projects above the surface of the steel disk body by between 0.1 and 2.0 millimeters.

In a more specific embodiment, an inlay can be used with a circular step forming a circular recess region formed into the steel disk body along the circular inner flat region proximate the circular beveled surface. The hard face coating can extend over and cover the circular recess region such that an external surface of the hard face coating is substantially flush with an external surface of the circular inner flat region (e.g. that is within 0 to 0.8 millimeter of flush).

In a more specific embodiment, the steel disk body comprises: an axial thickness of between 2 and 6 millimeters; an outermost thickness at the circular blade edge of between 0.1 and 2 millimeters; a diameter of between 20 and 100 centimeters; and with the beveled surface extending at an angle of between 5 and 45 degrees relative to the first flat side.

In a more specific embodiment, the hard face coating comprises a bead of laser cladding metallurgically bonded with the steel disk body.

An embodiment is also directed toward a method of making the seed disk opener comprising: melting a steel base material of the steel disk body with a laser to form a melt pool; depositing a stream of particles of a clad material into the melt pool; and solidifying the melt pool to affix the particles of the clad material.

In a more specific embodiment and in processing, the steel base material can comprise an initial hardness of between 35 and 55 HRC. Such processing can further comprise hardening a hardened region of the steel base material by increasing the initial hardness by at least 4 HRC in the hardened region of steel base material located immediately below the dilution zone. A remainder of the steel base material retains the initial hardness.

While an opener disk can be employed alone to form a furrow, an embodiment is also directed toward a seed opener assembly for use in a planter, comprising first and second opener disks that cooperate to form a soil furrow. Such an assembly can comprise a support carriage; and a pair of cooperating first and second gauge wheels mounted to a support carriage for rotation. First and second opener disks (with a hard face coating along the bevel thereof) are carried by the support carriage at a location between the gauge wheels for rotation about first and second axes, respectively. The first and second axes are oblique with the first and second opener disks converging toward a contact apex region or a narrow gap region proximate a bottom region thereof so as to form an inner V region opening away from the contact apex region or the narrow gap region for forming a soil furrow. The beveled surface of the opener disk for each of the first and second opener disks at the bottom region faces outwardly and on an opposite side of the inner V region for soil engagement. Preferably, the first and second opener disks are located forwardly and below the first and second gauge wheels.

Another embodiment is more generally directed toward a disk (e.g. that may be an opening disk or other such disk for agricultural or construction implements) comprising a steel disk body defining a central aperture and a circular blade edge at an outer periphery thereof. The steel disk body comprises a first side and a second side on opposite sides thereof. Each of the first side and a second side extends from the central aperture to the circular blade edge. The second side includes a circular beveled surface and a circular inner region. The circular beveled surface extends from the circular blade edge toward the central aperture and intersects the circular inner region. A hard face coating is provided on the circular beveled surface in which the hard face coating comprises a bead of laser cladding metallurgically bonded with the steel disk body.

In a more specific embodiment, the bead of laser cladding comprises at least one of the following materials: tungsten carbide, titanium carbide, iron carbide, diamond, ceramic, and other material having a Vickers scale hardness between HV 1200-2500; and wherein the steel disk body comprises a boron steel material having a Rockwell Hardness HRC of between 35 and 55.

In a more specific embodiment, the laser clad material is deposited into a steel base material of the steel disk body via forming a melt pool of the laser clad material and the steel base material to provide for a solidified dilution zone comprising a portion of base material intermixed with particles of clad material.

In a more specific embodiment, the dilution zone has an axial thickness of between 0.0 and 1.5 millimeters, and wherein a deposition zone comprising particles of the clad material is formed over of the dilution zone, wherein the clad material comprises particles having an average size of between 40 and 250 micron, and where wherein the clad material forms a bead having an average thickness of: between 0.1 and 2 millimeter extending normal to the second side for an opening disk, and/or between 0.2 and 3 millimeter extending normal to the second side more generally applied to disks.

In a more specific embodiment, the bead of laser cladding comprises a plurality of partially overlapping individual beads, with each of the partially overlapping individual beads being deposited on the steel disk body.

In a more specific embodiment, the bead of laser cladding comprises a plurality of individual beads, with each extending circumferentially around the steel disk body. Adjacent members of the individual beads can be radially adjacent to provide an outer individual bead surrounding an inner individual bead. For example, the beads can be laid in a circular pattern.

In a more specific embodiment, the bead of laser cladding is applied along the second side such that the hard face coating does not extend around the circular blade edge onto the first side and/or the first side is completely free of laser cladding.

In a more specific embodiment, the steel disk body of a disk comprises: an axial thickness of between 2.5 and 8 millimeters; an outermost thickness at the circular blade edge of between 0.3 and 3 millimeters; a diameter of between 20 and 100 centimeters; and wherein the beveled surface extends at an angle of between 5 and 45 degrees relative to the first flat side.

Another embodiment is more generally directed toward a disk comprising a steel disk body defining a central aperture and a circular blade edge at an outer periphery thereof. The steel disk body comprises a first side and a second side on opposite sides thereof. Each of the first side and a second side extends from the central aperture to the circular blade edge. The second side includes a circular beveled surface and a circular inner region. The circular beveled surface extends from the circular blade edge toward the central aperture and intersects the circular inner region. A hard face coating is on the circular beveled surface. The hard face coating is applied along the second side such that the hard face coating does not extend around the circular blade edge onto the first side.

In a more specific embodiment, first side is completely free of the hard face coating.

In a more specific embodiment, the hard face coating extends to and intersects the circular blade edge.

In a more specific embodiment, the hard face coating extends over an outer circular portion of the inner region and over a corner between the circular beveled surface and the circular inner region.

In a more specific embodiment, the hard face coating extends over a limited portion of the second side. The disk has a diameter of between 20 and 100 centimeters, with the hard face coating having an innermost location between 3 millimeters and 30 millimeters radially inward from the circular blade edge.

In a more specific embodiment, the hard face coating forms a raised plateau region along a surface of the steel disk body. The raised plateau region can project above the surface of the steel disk body by between 0.1 and 2.0 millimeters.

In a more specific embodiment, the disk may further comprise an inlay including a circular step forming a circular recess region formed into the steel disk body along the circular inner region proximate the circular beveled surface. The hard face coating extends over and covers the circular recess region such that an external surface of the hard face coating is substantially flush with an external surface of the circular inner region (e.g. that is within 0 to 1 millimeter of flush as applied more generally to disks).

In a more specific embodiment as applied to disks generally, the steel disk body can comprise: an axial thickness of between 2.5 and 8 millimeters; an outermost thickness at the circular blade edge of between 0.2 and 3 millimeters; a diameter of between 20 and 100 centimeters; with the beveled surface extending at an angle of between 5 and 45 degrees relative to the first flat side.

In one specific embodiment, the steel disk body is flat, while in another specific embodiment, the steel disk body is concave.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of a laser clad seed opener disk blade according to a first embodiment of the present invention;

FIG. 2 is a side view of the seed opener disk blade shown in FIG. 1;

FIG. 3 is an end view of the seed disk opener blade shown in FIG. 1;

FIG. 4 is a cross-section of FIG. 2 taken about section 4-4;

FIG. 5 is an enlarged detail view of a portion of FIG. 4 taken about circle 5 of FIG. 4;

FIG. 6 is an isometric view of a steel disk body for a seed opener disk blade according to a second embodiment of the present invention that includes a machined cutout region for laser cladding inlay;

FIG. 7 is a side view of the steel disk body shown in FIG. 6;

FIG. 8 is an end view of this steel disk body shown in FIG. 6;

FIG. 9 is an enlarged view of a portion of FIG. 8 taken about circle 9 showing the machined cutout state;

FIG. 10 is an enlarged view of a portion of FIG. 8 similar to FIG. 9 but taken about circle 10 and additionally illustrated to include the laser cladding filled into the machined surface as an inlay to complete the seed opener disk blade according to the second embodiment;

FIG. 11 is a partly schematic and diagrammatic view that is not to scale but provided for illustrative purposes to show a seed opener assembly employing either disk blades according to FIGS. 1-5 (the first embodiment) or disk blades according to FIGS. 6-10 (the second embodiment) in accordance with an embodiment of the present invention;

FIG. 12 is a partly schematic side elevation view of the seed opener assembly shown in FIG. 11;

FIG. 13 is a schematic not-to-scale enlarged view of a cross sectional region through the hard face coated region of the seed opener disk of the first embodiment or second embodiment for illustrative purposes to the show laser cladding being applied to a portion of a steel disk blade, in accordance with an embodiment of the present invention;

FIG. 14 is an enlarged not-to-scale cross sectional view of an inner flat region portion (not including the beveled surface) illustrating the step and resulting raised plateau portion at the inner diameter of the hard face coating for the opener disk of FIGS. 1-5 along with metallurgical bonding being schematically indicated, in accordance with an embodiment of the present invention that can be accomplished with the laser cladding method shown in FIG. 13;

FIG. 15 is an enlarged view of the cross section of FIG. 5 for the opener disk blade and further schematically illustrating that the bead of laser cladding may comprise a plurality of partially overlapping individual beads deposited on the steel disk body, in accordance with an embodiment of the present invention; and

FIG. 16 is a partly schematic side view of an arc segment of the outer periphery of the opener disk similar to that of FIG. 2 and according to the embodiment of FIG. 15 of laser cladding comprises a plurality of individual beads that partly overlap at radial edges, each extending circumferentially around the steel disk body.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

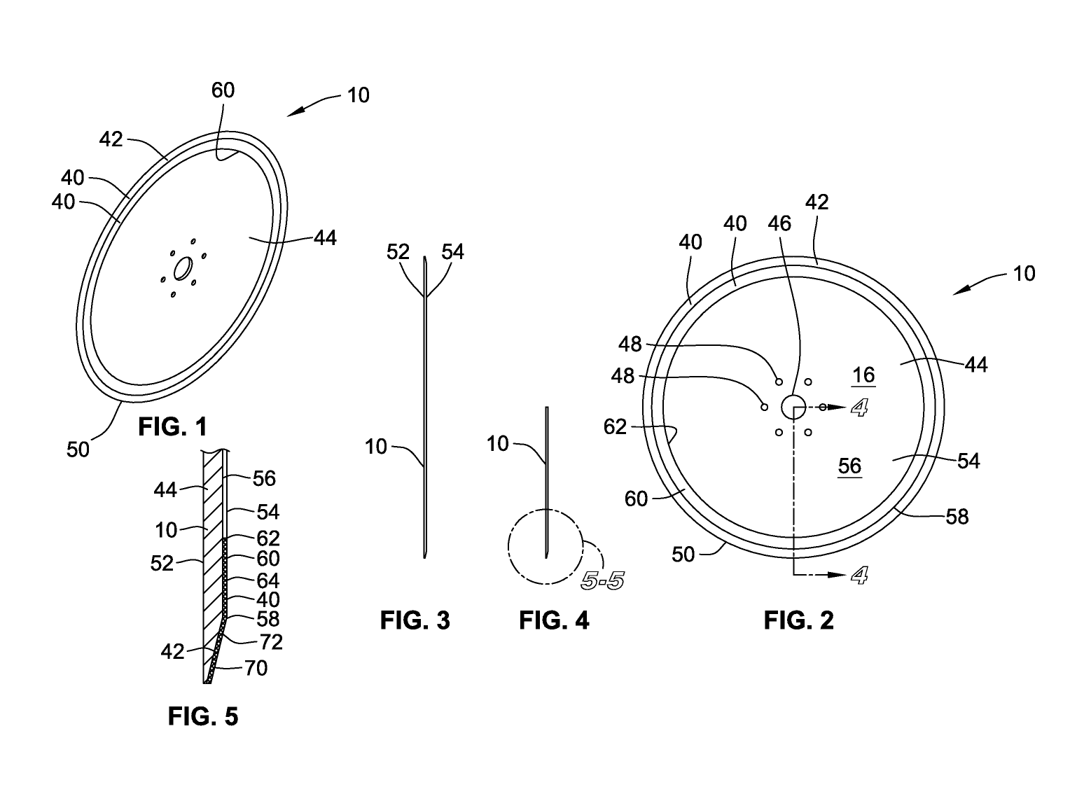

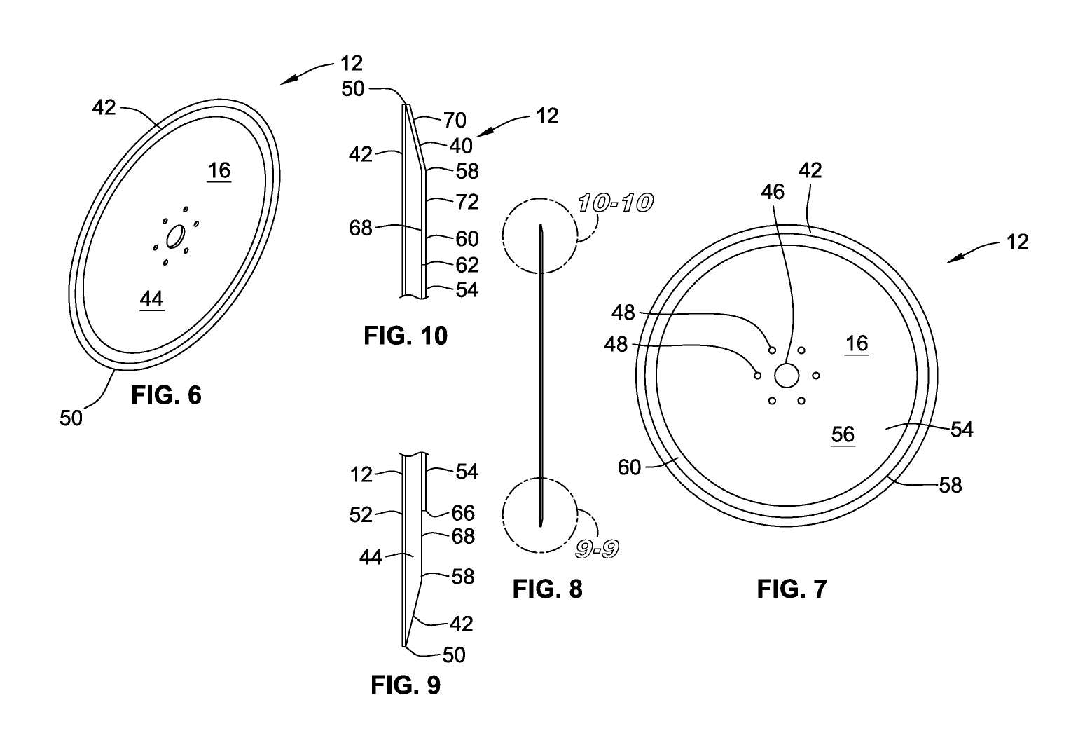

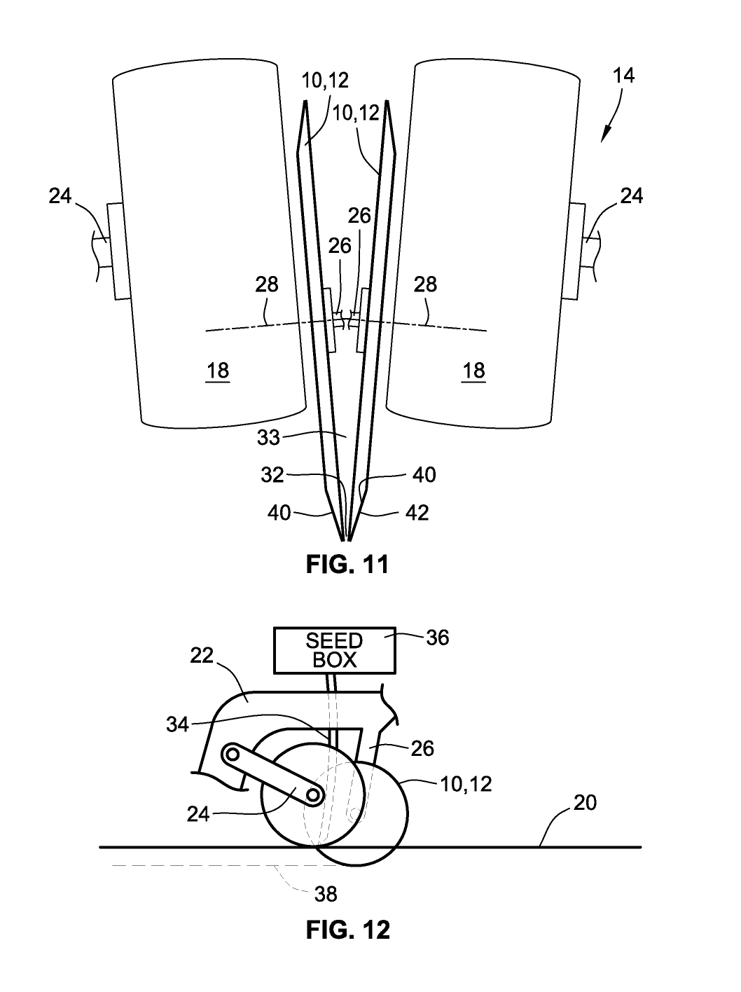

A preferred embodiment of the present invention is directed toward an opener disk blade that can be used in opening blade pairs for seed, fertilizer and insecticide and the like and is embodied as seed opener disk blade 10 of a first embodiment of FIGS. 1-5, or a seed opener disk blade 12 of a second embodiment of FIGS. 6-10. Either of the seed opener disk blades 10, 12 are configured for and can be mounted and used in a seed opener assembly 14 of a planter as shown in the schematic/diagrammatic illustrations of FIGS. 11 and 12. While certain aspects are directed more specifically to opener disk blades, it is understood broader aspects of the hard facing coating such as laser cladding applied to beveled surfaces of opener disk blades 10, 12 may more generally be directed toward other types of disk blades for other agricultural or construction implements according to other embodiments of the present invention. Those embodiments will be understood from the discussion of the opener disk blades 10, 12 embodiments discussed herein.

For context to better understanding use of the seed opener disk blades 10, 12, reference will first be had to the seed opener assembly 14 of a planter as shown in the FIGS. 11 and 12, which are shown in diagrammatic/schematic form for purposes of general understanding. These planters and seed opener assemblies are well understood by a person of ordinary skill, and it is understood that the seed opener disk blades of various embodiments may be employed in a wide variety of planter seed opener assemblies known in the art, such as shown in U.S. Pat. No. 4,729,802 to Matilis, and other examples, such as illustrated and/or described in the following U.S. patents of Published applications: US Publication 2017/0006757, to Andersen, entitled “DEPTH CONTROL SYSTEM FOR FRONT PIVOT AND REAR PIVOT GAUGE WHEEL ASSEMBLIES”; U.S. Pat. No. 8,577,561 to Green et. Al, entitled “Control system and method of operating a product distribution machine”; US Publication 2016/0100517 to Basset entitled “AGRICULTURAL SYSTEMS”; and US Publication 2015/0319919 to Sauders, entitled “AGRICULTURAL ROW UNIT SYSTEMS, METHODS, AND APPARATUS”, the entire disclosures of which are incorporated by reference for understanding various examples of planter seed opener assemblies for which the improved seed opener disk blades 10, 12 can be applied and used. It is also recognized that often that such opener disk blades 10, 12 are used in cooperating pairs, but there are also opener applications that comprise a single disk blade to form a corresponding soil furrow that could be either of the opener disk blades 10, 12.

Continuing to refer to FIGS. 11 and 12, the seed opener assembly 14 is one of several subassemblies often arranged in a linear array on a planter. The seed opener assembly 14 includes a cooperating pair of the seed opener disks 10 (or alternatively see opener disks 12) arranged a forward location, between and vertically below a pair of gauge wheels 18. The gauge wheels 18 are rotatably mounted to and carried by a support carriage 22 by mounting brackets 24. The seed opener disks 10 are also rotatably mounted to and carried by the support carriage 22 by independent and separate mounting brackets 26. The mounting brackets 24 and supporting axles thereof for the gauge wheels 18 typically extend along and over the outside of the gauge wheels 18, while the mounting brackets 26 and supporting axles thereof for the seed opener disks 10 typically extend along over the inside of the seed opener disks 10.

As can be seen, the axles of the mounting brackets 26 carry the seed opener disks 10 along the first and second axes 28, 30 that are oblique, such that the seed opener disks 10 converge toward a narrow gap region 32 or more typically a surface to surface contact apex region where the blades actually contact over a range of travel movement. The contact apex region or gap region 32 is at front location and near a bottom location so as to form an opening V region 33 that opens upwardly and rearwardly so as to receive a seed tube 34 that can carry a seed for plant distributed from a seed box distributor system 36 as schematically indicated. The seed opener disks 10 may be arranged at the same location relative from the side elevation, or in alternative embodiment staggered with one of the seed opener disks 10 located slightly in front of the other.

The gauge wheels 18 are arranged to ride along and roll over the soil surface 20 as shown in FIG. 12 to set the engaging depth of the seed opener disks 10, while the seed opener disks 10 roll and slice into the soil surface 20 creating a V-shaped seed furrow 38 for deposition of a seed fed through the seed tube 34. It can be appreciated that the seed opener disks 10 are therefore subject to substantial engagement with soil, including rocks and other debris (including crop residue or other vegetation), and thus subject to substantial wear forces that tend to scrape at the outside surface, while the inner surface is subject to metal to metal contact wear.

Turning to FIGS. 1-5 the seed opener disk 10 is provided with additional wear protection along the outside surface in the form of hard face coating 40 that is disposed on the circular beveled surface 42. In this embodiment, the seed opener disk 10 comprises a steel disk body 44 defining a central aperture (e.g. centermost hole 46 and/or central mounting holes 48). The steel disk body 44 extends outward therefrom to a circular blade edge 50 at an outer periphery thereof.

As applied to typical opener disk bodies, the disk body 44 comprises an inner flat side 52 and an outer flat side 54 on opposite sides thereof. When in use, the inner flat side 52 is arrange along and defines the V-region 33 at an interior of cooperating pairs of opener disks to provide a V-shaped volume for forming soil furrows. Each of the flat sides 52, 54 extend from the central aperture to the circular blade edge 50. However, the outer flat side 54 includes at the outer periphery thereof, the circular beveled surface 42, with a circular inner flat region 56 disposed radially inside thereof and surrounded by the beveled surface 42. As such, the circular beveled surface 42 extends from the circular blade edge 50 toward the centermost hole 46 and central mounting holes 48, but is limited to the periphery in a limited region that intersects the circular inner flat region 56 at a circular corner 58.

As can be seen, the hard face coating 40 is on the circular beveled surface 42, and preferably makes a continuous uninterrupted ring around the circular beveled surface 42.

In the present embodiment, the hard face coating 40 is applied along the outer flat side 54 in an unprotected region when used in an opener disk pair and in manner such that the hard face coating does not extend around the circular blade edge 50 onto the inner flat side 52. The inner flat side 52 can be completely free of the hard face coating 40. Separate and independent coating or inlays may be done along the inside for combating metal to metal wear along the mating circular edges.

To provide for initial protection and maintain diameter of the disk blade 10, the hard face coating 40 can extend to and intersect the circular blade edge 50. From the circular blade edge 50, the hard face coating 40 can extend radially inward completely over the beveled surface 42 and into an outer circular coated portion 60 of the inner flat region 56. As shown in FIG. 5, the hard face coating 40 is shown to extend over the circular corner 58 and extends into the inner flat region a limited distance. This limited distance typically relates to the depth to which the disk blades 10 engage into the soil surface, such that the initial soil contact is primarily between the hard face coating 40 and the soil, with the base steel material being protected during use.

For example, the hard face coating 40 may extends only over a limited portion of the outer flat side 54 (i.e. over the beveled surface 42 and/or over the circular coated portion), whereby the hard face coating has an innermost location 62 (e.g. location typically at the inner diameter of the hard face coating) that between 3 millimeters and 30 millimeters (more typically between 6 and 20 millimeters) radially inward from the circular blade edge 50. This range can provide suitable protection to the amount desired for opener disk blades that most typically define an outer diameter of between 30 and 40 centimeters.

In the first embodiment, the hard face coating 40 can be applied without any machining or forming of the outer flat side 54, which is contrary to the 2nd embodiment as will later be described. As a consequence, in the first embodiment, the hard face coating forms a raised plateau region 64 along the surface of the disk body 44. The raised plateau region 64 (e.g. corresponding to the thickness of the coating and in an embodiment the additive thickness of the laser clad bead that is deposited) projects above the surface of the steel disk body 44 by between 0.1 and 2.0 millimeters.

The disk 12 of the second embodiment of FIGS. 6-10 is the same as that as the first embodiment and as such the description of the first embodiment is applicable thereto (and as such like reference numbers are used) other than the fact the steel disk body 44 has been machined at its periphery. Machining is done to provide a circular step 66 in the outer flat side 54 forming a circular recess region 68 along the circular inner flat region 56 proximate the circular beveled surface 42. The diameter and location of the beveled surface 42 can remain the same in the 2nd embodiment other than being shaved a bit to a larger diameter from machining at the inner diameter due to the machined circular step 66. The hard face coating 40 extends over and covers the circular recess region 68 such that an external surface 70 of the hard face coating 40 is substantially flush with an external surface of the circular inner flat region 56 (e.g. substantially flush typically meaning within 0 to 0.8 millimeter of flush, and more preferably within 0.4 millimeters of level).

This secondary machining step as in the second embodiment could be performed to the disk 12 to create an inlay of laser clad material in order to ensure a smooth face on the disk 12. This step is not necessary as evident from the first embodiment but is added to address the preference of some end users to run their gauge wheels up tight to the disk.

In either of the first and second embodiments and as applied to typical opener disks to which significant application applies, the steel disk body can comprise: an axial thickness of between 2 and 8 millimeters (more typically between 3 and 5 millimeters); an outermost thickness at the circular blade edge of between 0.1 and 2 millimeters (more typically between 0.3 and 1.5 millimeters); and a diameter of between 20 and 100 centimeters (more typically between 30 and 40 centimeters). The beveled surface typically extends at an angle of between 5 and 45 degrees relative to the first flat side to provide sharpness for slicing through the soil surface.

Also while various hard face coatings are contemplated and can provide some benefit, preferably, the hard face coating 40 comprises a bead of laser cladding 72 that forms a metallurgical bond with the steel disk body 44. The laser cladding 72 is also the chosen coating technology due to its minimal distortion as the blade flatness is critical when applied to certain seed opener application embodiments. In addition to the coating, the laser process will also produce a higher hardness in the base material of the steel disk body 44 (e.g. in the regions immediate proximate the laser heat application) than is present in the disk blade prior to cladding. Embodiments herein are not restricted to coating before or after heat treatment of the base disk blade. The laser cladding 72 can be deposited in a circular pattern or in a back forth incremental pattern. Depending upon the width of laser cladding laid down, the overall coating 40 may comprise several adjacent beads (e.g. a spiral bead application, or back and forth radially inward and outward pattern), in which adjacent beads preferably may partially overlap each other at adjacent bead edge regions.

The material used in the laser cladding 72 coating could include many different materials. The proper hard face material would be determined by the application (i.e. sandy soils might use one material where rocky soils might use a different material). A laser cladding 72 coating thickness typically will range from 0.2 mm thick to 1.5 mm thick. The width of the coating material could range from just covering the bevel to as much as 30 mm in total width.

For example, the bead of laser cladding 72 can comprise particles of at least one of the following materials: tungsten carbide, titanium carbide, iron carbide, diamond, ceramic, and other material having a Vickers scale hardness between HV 1200-2500. In contrast, the steel disk body 44 is typically a boron steel material member having a Rockwell Hardness HRC of between 35 and 55.

In general, the process of laser cladding and forming the bead of laser cladding 72 on the disk body 44 is the process of cladding material with the desired properties and fusing it onto the substrate by means of a laser beam. Laser cladding can yield surface layers that when compared to other hard facing techniques or standard blade material can have superior properties in terms of hardness, bonding, corrosion resistance and microstructure.

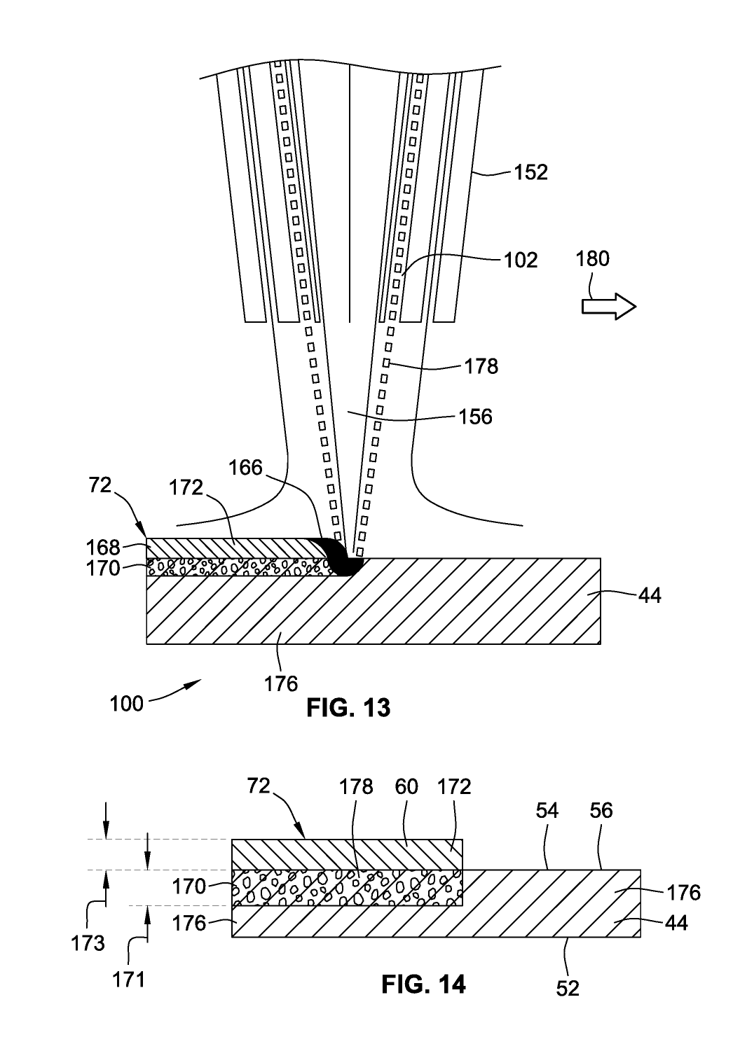

In an embodiment and with additional reference to FIGS. 13 and 14, laser cladding technology is utilized in a method to deposit the cladding on and into the beveled surface (and adjacent regions) of the disk body 44 with the laser cladding tool/laser 152 and thereby metallurgically bond the particles of cladding material 102 to the steel base material 176 of the disk body 44. The laser 152 may include using at least one of the following lasers; CO2, YAG, Diode and fiber. A laser beam 156 is created by the laser tool 152 and consists of a column of light energy of similar wave length. These different types of lasers produce different wave lengths of light. These lasers each have their own unique characteristics, but all work well in the method described herein. The foregoing lasers are not meant to be limiting examples as other lasers can be employed.

As illustrated in FIG. 13, the laser 152 creates a shallow melt pool 166 of the base material 176. The cladding material 102 is comprised of particles 178 that are introduced into the melt pool 166 in powder form. The energy from the laser 152 subsequently melts binding materials of the cladding material 102. After solidification of the melt pool 166 a dilution zone 170 remains wherein true metallurgical bond affixing the particles 178 of the clad material 102 and the base material 176 remains under and a deposition zone 168 comprising only the laser clad material 102 to form the bead of laser cladding 72. Preferably the dilution zone 170 has a dilution zone thickness 171 that is less than 0.5 millimeters and more preferably less than 0.13 millimeters thick.

Typically the hard/wear resistant laser clad material 102 referred to in various embodiments of the invention is material composed of a medium to high percentage of hard particles. These hard particles can be: Tungsten Carbide, Titanium Carbide, Chrome Carbide, Iron Carbide, Diamond, Ceramics, or any other high hardness particles in the range of HV 1200-2500 (Vickers scale hardness). The high hardness particles are then bonded and held in place to the base material through the metallurgical bond. In the alternative to carbides, powders of various metal alloys or other amorphous materials may be laser clad or otherwise deposited according to embodiments of the present invention. Carbide alternatives as envisioned or discloses in U.S. Pat. No. 6,887,586 or U.S. RE 29,989 (see also U.S. Pat. No. 3,871,836), the entire teachings and disclosures of which are incorporated herein by reference.

As discussed above, when the clad material 102 is deposited into the base material 176 of the inner flat region 56 and beveled surface 42 (not shown in FIG. 14), it forms the deposition zone 168 over the dilution zone 170. The deposition zone 168 (which is primarily particles and greater than 50% particles) formed of the laser clad material 102 forms a material bead 172 that extends normal to the surface of the base material and continuously around the beveled surface 42 and preferably along a circular coated portion 60 of the inner flat region 56 as shown in FIGS. 1-5. The material bead 172 has an average thickness 173 between 0.1 millimeters and 2 millimeters. This provides a raised surface or plateau region of corresponding thickness of 0.1 to 2 millimeters, which can comprise a single deposited bead (in other embodiments overlaid beads may be placed on top of each other to create thickness).

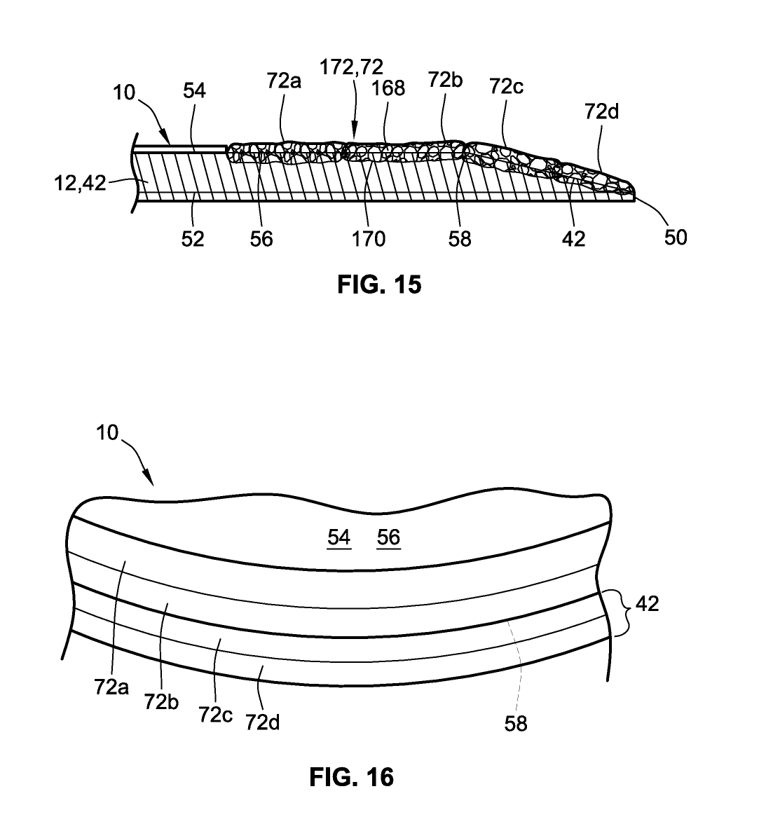

An example wherein the material bead 172 comprises partly overlaid individual beads 72a, 72b, 72c, 72d that collectively form the overall laser cladding 72 to provide the hard face is illustrated in the embodiment of FIGS. 15 and 16. For example each of the individual beads 72a, 72b, 72c, 72d may have a width of between 2 and 20 millimeters to provide the overall radial span of the laser cladding 72. Preferably, the individual beads 72a, 72b, 72c, 72d partly overlap at radial edges and preferably have a thickness of one laser clad deposition, and each extending circumferentially around the steel disk body 12 in a circular pattern at the periphery as shown. While 4 partly overlapping beads are illustrated, typically between 2-4 partly overlapping beads to provide for the overall laser cladding 72 can be used for disk applications. This provides for overall coverage while maintain a laser cladding deposit thickness that is relatively shallow to maintain sufficient sharpness of the circular blade edge 50, also the application direction of the laser can be optimized for the beveled surface 42 and the inner flat region 56 deposition area, with different attack angles for each. Also shown schematically in FIG. 15, is that the dilution zone 170 metallurgical bonds the clad material with the base material and a deposition zone 168 is provided on top, pursuant to the discussion of FIGS. 13 and 14 during a laser cladding process. With reference again to FIGS. 13 and 14, the dilution zone 170 contains base material 176 intermixed with particles 178 of the clad material 102 but may be 50% or more base material. The particles 178 of the clad material 102 are of a second hardness greater than the first hardness of the base material 176. The particles 178 of the clad material 102 preferably have an average size of between 40 μm and 250 μm and more preferably between 44 μm and 105 μm.

Preferably the dilution zone 170 has a dilution zone thickness 171 that is between 0.0 and 1.5 millimeters thick. These areas provide the advantage of strong bonding and minimized distortion of the base material 176 that result in the advantage of less or no post cladding machining and processing to correct distortion than other known process.

The deposition zone 168 and the dilution zone 170 provide the advantage of strong bonding and minimized distortion of the base material 176 and thus further results in the advantage that no post cladding machining or processing is necessary to correct distortion that can occur in other processes that attempt to provide a hard and sharp circular blade edge 50 via a hard wear resistant laser clad region adjacent thereto.

The laser cladding can also increase the hardness of the steel base material immediately adjacent. The steel base material comprises an initial hardness of between 35 and 55 HRC. The laser cladding may harden and form a hardened region of the steel base material by increasing the initial hardness by at least 4 HRC in the hardened region of steel base material located immediately below the dilution zone. A remainder of the steel base material (e.g. the remainder being displaced from the laser cladding deposition) retains the initial hardness.

While the above described embodiments have particular application and benefit to opener disk applications, alternative embodiments are contemplated and covered by certain broader claims appended hereto. For example, while opener disk blades are conventionally flat, many blades such as for harrows or other applications are concave, but these also have a beveled surface region thereon can have a similar hard face coating of laser cladding. Further, various disk blades can be serrated or notches, but the serrated or notched blade edge still follows a circular pattern around a central axis and therefore circular within the context herein. “A geometrical circle edge” such as shown for the first and second embodiment is a form of circular edge and is a term that can be used herein to describe a non-serrated or non-notched circular edge such as in the first and second illustrated embodiments.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An opener disk, comprising:
a steel disk body defining a central aperture and a circular blade edge at an outer periphery thereof, the steel disk body comprising a first flat side and a second side on opposite sides thereof, each of the first flat side and a second side extending from the central aperture to the circular blade edge, the second side including a circular beveled surface and a circular inner flat region, the circular beveled surface extending from the circular blade edge toward the central aperture and intersecting the circular inner flat region; and
a hard face coating on the circular beveled surface.

2. The opener disk of claim 1, wherein the hard face coating is applied along the second side such that the hard face coating does not extend around the circular blade edge onto the first flat side.

3. The opener disk of claim 1, wherein first side is completely free of the hard face coating.

4. The opener disk of claim 1, wherein the hard face coating extends to and intersects the circular blade edge.

5. The opener disk of claim 1, wherein the hard face coating extends over an outer circular portion of the inner flat region and over a corner between the circular beveled surface and the circular inner flat region.

6. The opener disk of claim 1, wherein the hard face coating extends over a limited portion of the second side, wherein the opener disk has a diameter of between 30 and 40 centimeters, and wherein the hard face coating has an innermost location between 3 millimeters and 30 millimeters radially inward from the circular blade edge.

7. The opener disk of claim 1, wherein the hard face coating forms a raised plateau region along a surface of the steel disk body, the raised plateau region projecting above the surface of the steel disk body by between 0.1 and 2.0 millimeters.

8. The opener disk of claim 1, further comprising a circular step forming a circular recess region formed into the steel disk body along the circular inner flat region proximate the circular beveled surface, and wherein the hard face coating extends over and covers the circular recess region such that an external surface of the hard face coating is substantially flush with an external surface of the circular inner flat region that is within 0 to 0.8 millimeter of flush.

9. The opener disk of claim 1, wherein the steel disk body comprises:
an axial thickness of between 2 and 8 millimeters;
an outermost thickness at the circular blade edge of between 0.1 and 2 millimeters;
a diameter of between 20 and 100 centimeters;
and wherein the beveled surface extends at an angle of between 5 and 45 degrees relative to the first flat side.

10. The opener disk of claim 1, wherein the hard face coating comprises a bead of laser cladding metallurgically bonded with the steel disk body.

11. The opener disk of claim 10 wherein the bead of laser cladding comprises at least one of the following materials: tungsten carbide, titanium carbide, iron carbide, diamond, ceramic, and other material having a Vickers scale hardness between HV 1200-2500; and wherein the steel disk body comprises a boron steel material having a Rockwell Hardness HRC of between 35 and 55.

12. The opener disk of claim 10, wherein the bead of laser cladding comprises laser clad material deposited into a steel base material of the steel disk body via forming a melt pool of the laser clad material and the steel base material to provide for a solidified dilution zone comprising a portion of base material intermixed with particles of clad material.

13. The opener disk of claim 12, wherein the dilution zone has an axial thickness of between 0.0 and 1.5 millimeters, and wherein a deposition zone comprising particles of the clad material is formed over of the dilution zone, wherein the clad material comprises particles having an average size of between 40 and 250 micron, and where wherein the clad material forms a bead having an average thickness of between 0.1 and 2 millimeter extending normal to the second side.

14. A method of making the seed disk opener of claim 1, comprising:
melting a steel base material of the steel disk body with a laser to form a melt pool;
depositing a stream of particles of a clad material into the melt pool; and
solidifying the melt pool to affix the particles of the clad material.

15. The method of claim 14, wherein the steel base material comprises an initial hardness of between 35 and 55 HRC, and further comprising: hardening a hardened region of the steel base material by increasing the initial hardness by at least 4 HRC in the hardened region of steel base material located immediately below the dilution zone, and wherein a remainder of the steel base material retains the initial hardness.

16. A seed opener assembly for use in a planter, comprising first and second opener disks that each comprise a separate member of the opener disk of claim 1, comprising:
a support carriage;
a pair of cooperating first and second gauge wheels mounted to a support carriage for rotation with the first and second opener disks carried therebetween by the support carriage for rotation about first and second axes, respectively, the first and second axes being oblique with the first and second opener disks converging toward a contact apex region or a narrow gap region proximate a bottom region thereof so as to form an inner V region opening away from the contact apex region or the narrow gap region for forming a soil furrow, the beveled surface of the opener disk for each of the first and second opener disks at the bottom region faces outwardly and on an opposite side of the inner V region for soil engagement.

17. The opener assembly of claim 16, wherein first and second opener disks are located forwardly and below the first and second gauge wheels.

18. A disk, comprising:
a steel disk body defining a central aperture and a circular blade edge at an outer periphery thereof, the steel disk body comprising a first side and a second side on opposite sides thereof, each of the first side and a second side extending from the central aperture to the circular blade edge, the second side including a circular beveled surface and a circular inner region, the circular beveled surface extending from the circular blade edge toward the central aperture and intersecting the circular inner region; and
a hard face coating on the circular beveled surface, wherein the hard face coating comprises a bead of laser cladding metallurgically bonded with the steel disk body.

19. The disk of claim 18 wherein the bead of laser cladding comprises at least one of the following materials: tungsten carbide, titanium carbide, iron carbide, diamond, ceramic, and other material having a Vickers scale hardness between HV 1200-2500; and wherein the steel disk body comprises a boron steel material having a Rockwell Hardness HRC of between 35 and 55.

20. The disk of claim 18, wherein the bead of laser cladding comprises laser clad material deposited into a steel base material of the steel disk body via forming a melt pool of the laser clad material and the steel base material to provide for a solidified dilution zone comprising a portion of base material intermixed with particles of clad material.

21. The disk of claim 20, wherein the dilution zone has an axial thickness of between 0 and 1.5 millimeters, and wherein a deposition zone comprising particles of the clad material is formed over of the dilution zone, wherein the clad material comprises particles having an average size of between 40 and 250 micron, and where wherein the clad material forms a bead having an average thickness of between 0.2 and 3 millimeter extending normal to the second side.

22. The disk of claim 18, wherein the bead of laser cladding is applied along the second side such that the hard face coating does not extend around the circular blade edge onto the first side.

23. The disk of claim 18, wherein first side is completely free of laser cladding.

24. The disk of claim 18, wherein the steel disk body comprises:
an axial thickness of between 2.5 and 8 millimeters;
an outermost thickness at the circular blade edge of between 0.3 and 3 millimeters;
a diameter of between 20 and 100 centimeters;
and wherein the beveled surface extends at an angle of between 5 and 45 degrees relative to the first flat side.

25. A disk, comprising:
a steel disk body defining a central aperture and a circular blade edge at an outer periphery thereof, the steel disk body comprising a first side and a second side on opposite sides thereof, each of the first side and a second side extending from the central aperture to the circular blade edge, the second side including a circular beveled surface and a circular inner region, the circular beveled surface extending from the circular blade edge toward the central aperture and intersecting the circular inner region; and
a hard face coating on the circular beveled surface, wherein the hard face coating is applied along the second side such that the hard face coating does not extend around the circular blade edge onto the first side.

26. The disk of claim 25, wherein first side is completely free of the hard face coating.

27. The disk of claim 25, wherein the hard face coating extends to and intersects the circular blade edge.

28. The disk of claim 25, wherein the hard face coating extends over an outer circular portion of the inner region and over a corner between the circular beveled surface and the circular inner region.

29. The disk of claim 25, wherein the hard face coating extends over a limited portion of the second side, wherein the disk has a diameter of between 20 and 100 centimeters, and wherein the hard face coating has an innermost location between 3 millimeters and 30 millimeters radially inward from the circular blade edge.

30. The disk of claim 25, wherein the hard face coating forms a raised plateau region along a surface of the steel disk body, the raised plateau region projecting above the surface of the steel disk body by between 0.1 and 2.0 millimeters.

31. The disk of claim 25, further comprising a circular step forming a circular recess region formed into the steel disk body along the circular inner region proximate the circular beveled surface, and wherein the hard face coating extends over and covers the circular recess region such that an external surface of the hard face coating is substantially flush with an external surface of the circular inner region that is within 0 to 1 millimeter of flush.

32. The disk of claim 25, wherein the steel disk body comprises:
an axial thickness of between 2.5 and 8 millimeters;
an outermost thickness at the circular blade edge of between 0.2 and 3 millimeters;
a diameter of between 20 and 100 centimeters;
and wherein the beveled surface extends at an angle of between 5 and 45 degrees relative to the first flat side.

33. The disk of claim 25, wherein the steel disk body is flat.

34. The disk of claim 25, wherein the steel disk body is concave.

35. The opener disk of claim 10, wherein the bead of laser cladding comprises a plurality of partially overlapping individual beads, each of the partially overlapping individual beads being deposited on the steel disk body.

36. The opener disk of claim 10, wherein the bead of laser cladding comprises a plurality of individual beads, each extending circumferentially around the steel disk body, with adjacent members of the individual beads being radially adjacent to provide an outer individual bead surrounding an inner individual bead.

37. The opener disk of claim 18, wherein the bead of laser cladding comprises a plurality of partially overlapping individual beads, each of the partially overlapping individual beads being deposited on the steel disk body.

38. The opener disk of claim 18, wherein the bead of laser cladding comprises a plurality of individual beads, each extending circumferentially around the steel disk body, with adjacent members of the individual beads being radially adjacent to provide an outer individual bead surrounding an inner individual bead.
